(19) United States
(12) Patent Application Publication
(10) Pub. No.: US 2017/0371896 A1
(43) Pub. Date: Dec. 28, 2017

(54) FILE SYSTEM IMAGE PROCESSING SYSTEM

(71) Applicant: eBay Inc., San Jose, CA (US)

(72) Inventors: Vinay Kumar Pachunoori, Banglore (IN); Aroop Maliakkal Padmanabhan, Kerala (IN); Senthilkumar Kalaiselvan, Tamilnadu (IN)

(21) Appl. No.: 15/191,085

(22) Filed: Jun. 23, 2016

(51) Int. Cl. G06F 17/30

(52) U.S. Cl. CPC G06F 17/30227; G06F 17/30088; G06F 17/30091

(57) ABSTRACT

In various example embodiments, a system and method for processing a file system image of a file system are presented. In an example, a file system image processing system may include an image processor module to access a file system image stored at a first server of a file system while the file system image is not being modified, and to store a representation of the file system image. Further, the file system image processing system may include a transaction processor module to repeatedly access transaction data stored at a second server of the file system separate from the first server, in which the transaction data describes file system edit transactions not represented in the accessed file system image. The transaction processor module may modify the representation of the file system image based on the accessed transaction data.

### TECHNICAL FIELD

Embodiments of the present disclosure relate generally to data processing and, more particularly, but not by way of limitation, to processing of file system images.

### BACKGROUND

As the amount of data an organization receives and processes increases, the ability to handle that data efficiently and cost-effectively may be important factors affecting organization productivity, operational efficiency, and customer satisfaction. Generally, the larger the data set involved, the greater the size of the computing infrastructure, such as the number of data servers, data storage systems, and the like that are included in the overall system. To ensure efficient operation, data regarding the current state of the overall system, the operational effectiveness in response to various conditions, and so on, may be captured and analyzed so that appropriate changes to the system may be effectuated to improve performance, efficiency, and so forth on an ongoing basis.

More specifically with respect to data storage systems, a snapshot of the various directories and files of the file system, as well as the size, location, and other aspects of the file system, often referred to as the file system “image,” may be captured and analyzed periodically. However, such images of extremely large data storage systems often require several hours to obtain, thus possibly causing such images to become outdated quickly, thus reducing their analytical value.

### BRIEF DESCRIPTION OF THE DRAWINGS

Various ones of the appended drawings merely illustrate example embodiments of the present disclosure and cannot be considered as limiting its scope.

FIG. 1 is a block diagram of an example data storage cluster coupled with an example file system image processing system.

FIG. 2 is a block diagram of an example of the file system image processing system of FIG. 1, including an example initial image loader/processor and an example transaction loader/processor.

FIG. 3 is a flow diagram of an example method of processing a file system image.

FIG. 4 is a block diagram of an example of the initial image loader/processor of FIG. 2.

FIGS. 5A and 5B depict an example file system image.

FIG. 6 depicts an example path/size text file that may be generated by the initial image loader/processor of FIG. 4.

FIG. 7 depicts an example image database store employable by the initial image loader/processor of FIG. 4.

FIG. 8 is a block diagram of an example of the transaction loader/processor of FIG. 2.

FIG. 9 depicts an example edit log transaction employable by the transaction loader/processor of FIG. 8.

FIG. 10 depicts an example code segment for an example access scheduler employable in the transaction loader/processor of FIG. 8.

FIG. 11 depicts an example code segment for an example log-to-memory loader employable in the transaction loader/processor of FIG. 8.

FIG. 12 depicts an example code segment for an example edit transaction parser employable in the transaction loader/processor of FIG. 8.

FIG. 13 is a block diagram of an example image analyzer employable in the file system image processing system of FIG. 1.

FIG. 14 is a block diagram illustrating an example of a software architecture that may be installed on a machine, according to some example embodiments.

FIG. 15 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

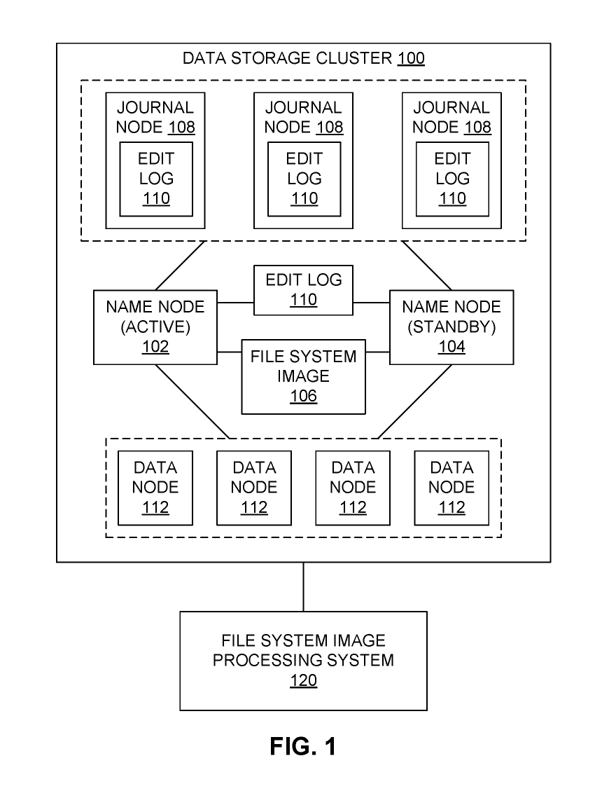

FIG. 1 is a block diagram of an example data storage cluster 100 coupled with an example file system image processing system 120. In various examples described below, the data storage cluster 100 may be a data storage cluster of a Hadoop® Distributed File System (HDFS). However, other types of file systems may benefit from application of one or more of the various aspects of the systems and methods disclosed herein. Further, while various aspects of the file system image processing system 120 are described in relation to a single data storage cluster 100, an overall data storage system may include one or more data storage clusters 100, with one or more different file system image processing systems 120 coupled to the data storage system. Each of the various devices or systems of FIG. 1, as well as other devices or systems discussed more fully below, may be coupled together by way of a communication network, such as a wide area network (WAN) (e.g., the Internet), a wireless WAN (WWAN), a local area network (LAN), a wireless LAN (WLAN), a virtual private network (VPN), another type of network, or a combination of two or more such networks.

As shown in FIG. 1, the data storage cluster 100 may include one or more name nodes 102, 104 (e.g., an HDFS NameNode). In this particular example, an active name node 102 (e.g., an HDFS NameNode) and a standby name node 104 (e.g., and HDFS BackupNode) are employed. The active name node 102 may be a server or other system responsible for managing and updating a file system image 106 (e.g., an HDFS FSImage) and/or an edit log 110 (e.g., an HDFS edit log or journal) in response to various file system operations (e.g., directory and/or file creation and/or deletion, file updating, and so on) requested by one or more client devices (not shown in FIG. 1). The standby name node 104 may be responsible for maintaining access to the file system image 106 and/or the edit log 110, and/or maintaining its own copy of the file system image 106 and/or the edit log 110, in preparation for operating as a replacement for the active name node 102 in the event of a failure of the active name node 102.

The file system image 106 may include “name space” information (e.g., the HDFS “namespace”) identifying the hierarchical directory and file structure of the file system, the location and/or size of various portions (e.g., “blocks”) of the directories and files, and/or so on. The actual data carried in the various files may be stored in one or more data nodes 112 (e.g., an HDFS DataNode), which may be embodied in one or more data storage devices (e.g., hard disk drives, optical disk drives, flash drives, and so on), servers, or systems. In some examples, each file system object (e.g., a file, directory, or the like) may be considered to be a separate “inode” of the file system.

In some examples, the active name node 102 may only periodically update the file system image 106. More specifically, the active name node 102 may record or register file system operations, or “transactions,” in the edit log 110 as they occur. Periodically, the active name node 102 may then update the file system image 106 using the transactions recorded in the edit log 110 and remove or “flush” the data regarding those transactions from the edit log 110. In some examples, the active name node 102 may update the file system image 106 using all of the transactions recorded the edit log 110 to generate a “checkpoint” file that the active name node 102 may utilize to reinitialize the file system image 106, such as upon a restart of the active name node 102. In some examples, the recorded transactions may be grouped into transaction “segments” in the edit log 110, with each segment denoting transactions that occurred during a particular time period.

The active name node 102 may also record the transactions in one or more corresponding edit logs 110 stored in one or more journal nodes 108 (e.g., an HDFS JournalNode), for example, to provide a level of redundancy and fault tolerance to the file system.

As is described in greater detail below, the file system image processing system 120 may communicate with various nodes and systems of the data storage cluster 100 to provide rapid and up-to-date access to the data represented in the file system image 106 and the edit log 110 to facilitate efficient and effective analysis of the file system.

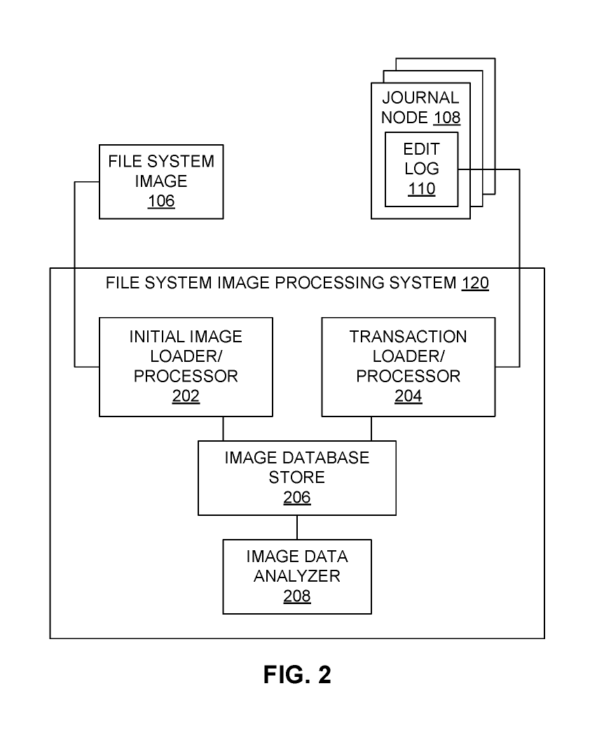

FIG. 2 is a block diagram of an example of the file system image processing system 120 of FIG. 1, including an example initial image loader/processor 202 and an example transaction loader/processor 204. As shown in FIG. 2, the initial image loader/processor 202 may access the file system image 106 of the data storage cluster 100 of FIG. 1, while the transaction loader/processor 204 may access the edit log 110 of one or more journal nodes 108. In some examples, the initial image loader/process 202 may access the file system image 106 once, after which the transaction loader/processor 204 may repetitively or repeatedly access the edit log 11 of a journal node 108 to continually update a local representation of the file system image 106 as file system operations continue to be executed. By accessing the edit log 110 of a journal node 108, as opposed to the edit log 110 more closely associated with the active name node 102 of FIG. 1, the initial image loader/processor 202 may not adversely impact the operation of the active name node 102. In other examples, the initial image loader/processor 202 may access the edit log 110 stored at, or otherwise coupled closely to, the active name node 102.

The file system image processing system 120 may also include an image database store 206 to which the initial image loader/processor 202 may load a representation of the file system image 106, and which the transaction loader/processor 204 may modify from time to time using the transactions recorded in the edit log 110. The file system image processing system 120 may also include one or more image data analyzers 208 that access the representation of the file system provided in the image database store 206 to retrieve and analyze various aspects of the file system, as well as to provide reports, alerts, and so on to other devices (e.g., computing or communication devices of file system operators or administrators). In some examples, the initial image loader/processor 202, the transaction loader/processor 204, and/or the image data analyzer 208 may include one or more processors (e.g., microprocessor, microcontrollers, or the like) and one or more memory devices storing instructions executable by the one or more processors to perform the various operations ascribed herein to each of the image loader/processor 202, the transaction loader/processor 204, and/or the image data analyzer 208.

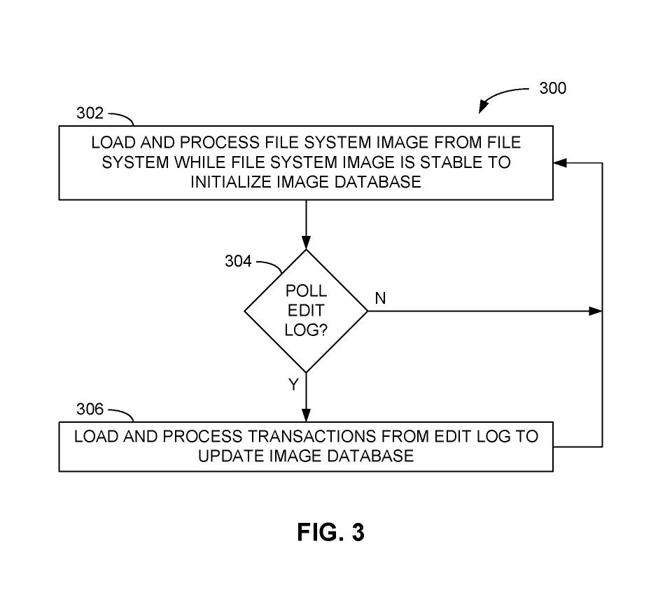

FIG. 3 is a flow diagram of an example method 300 of processing and updating a representation of a file system image (e.g., using the file system image 106 of FIG. 1). While execution of the method is described in conjunction with the file system image processing 120 of FIGS. 1 and 2, other systems or devices not specifically described herein may be employed to perform the method 300 in other examples.

In the method 300, a file system image (e.g., the file system image 106 of FIG. 1) may be loaded from a file system and processed (e.g., by the initial image loader/processor 202) while the file system image is stable to initialize an image database (e.g., the image database store 206 of FIG. 2) (operation 302). If an edit log (e.g., the edit log 110 of a journal node 108 of FIG. 1) is to be polled (operation 304), one or more transactions may be loaded and processed (e.g., by the transaction loader/processor 204 of FIG. 2 from the edit log 110) to update the image database (operation 306). In one example, the polling of the edit log 110 may occur once per some specified time period, in response to some detected event, and/or some combination thereof. By repeatedly performing the polling of the edit log 110, the image database may be kept up-to-date in near-real-time as the file system operations are executed.

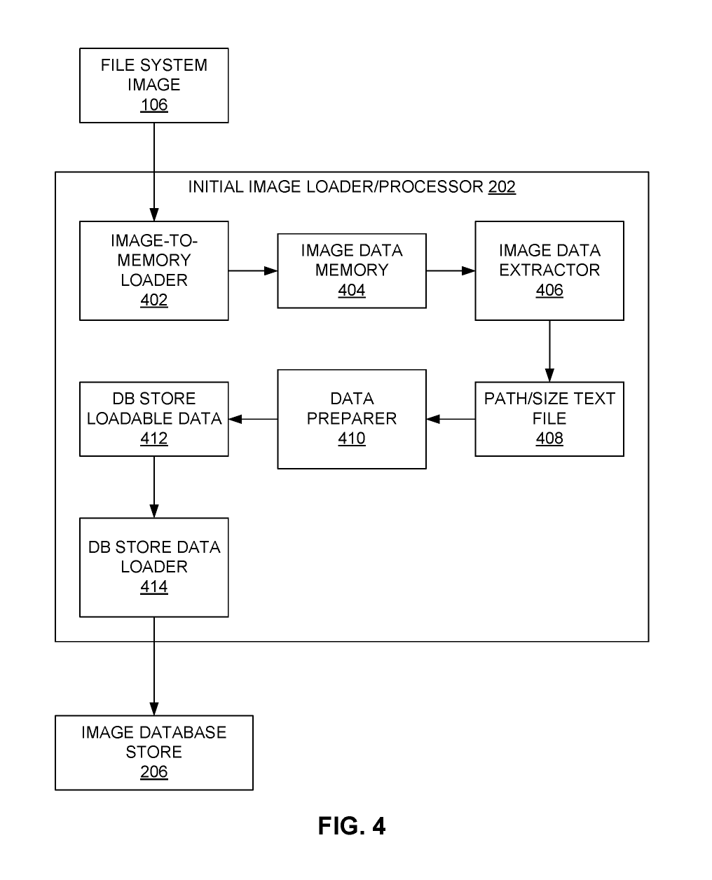

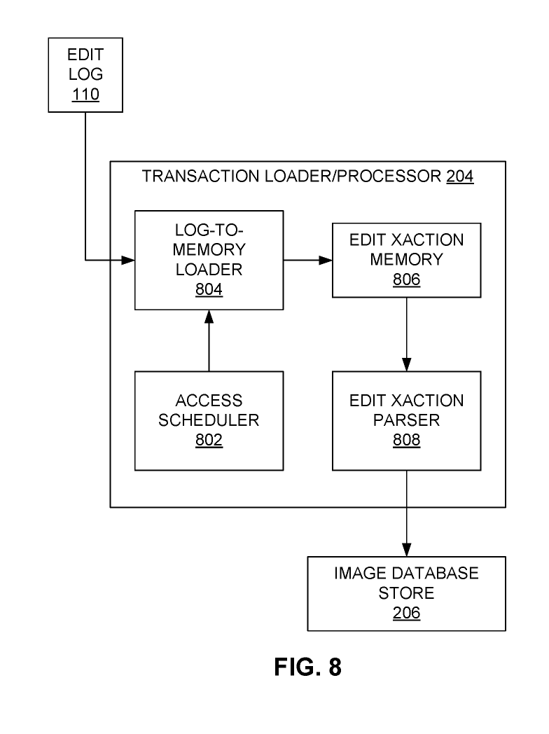

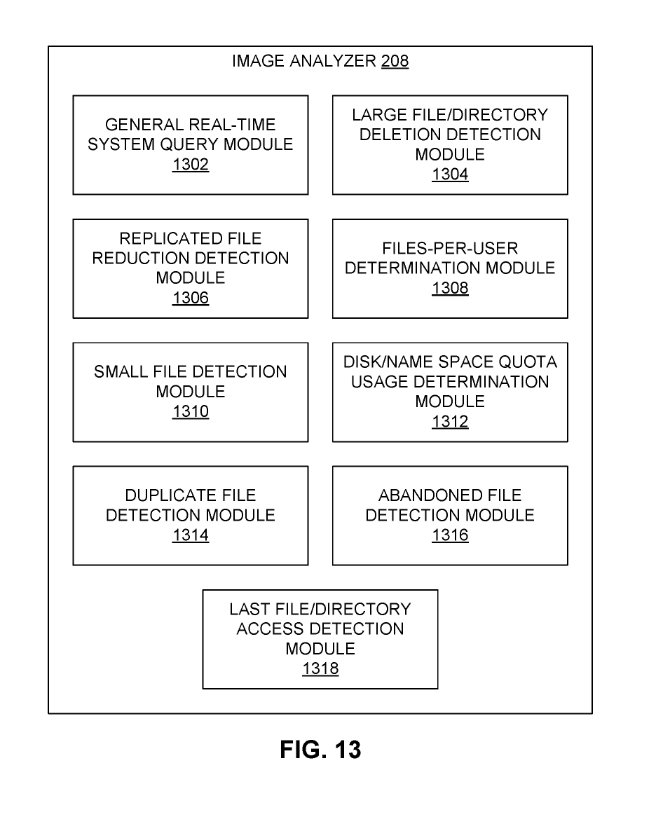

FIG. 4 is a block diagram of an example of the initial image loader/processor 202 of FIG. 2, which may include a number of modules, such as an image-to-memory loader 402 to load image data to an image data memory 404, an image data extractor 406 to generate a path/size text file 408, a data preparer 410 to generate database store loadable data 412, and a database store data loader 414. Each of the modules 402, 406, 410, and 414 of the initial image loader/processor 202 of FIG. 4, as well as those of the transaction loader/processor 204 of FIG. 8 and the image analyzer 208 of FIG. 13, may collectively be one or more hardware processors executing instructions stored in memory to perform the operations associated with the particular module.

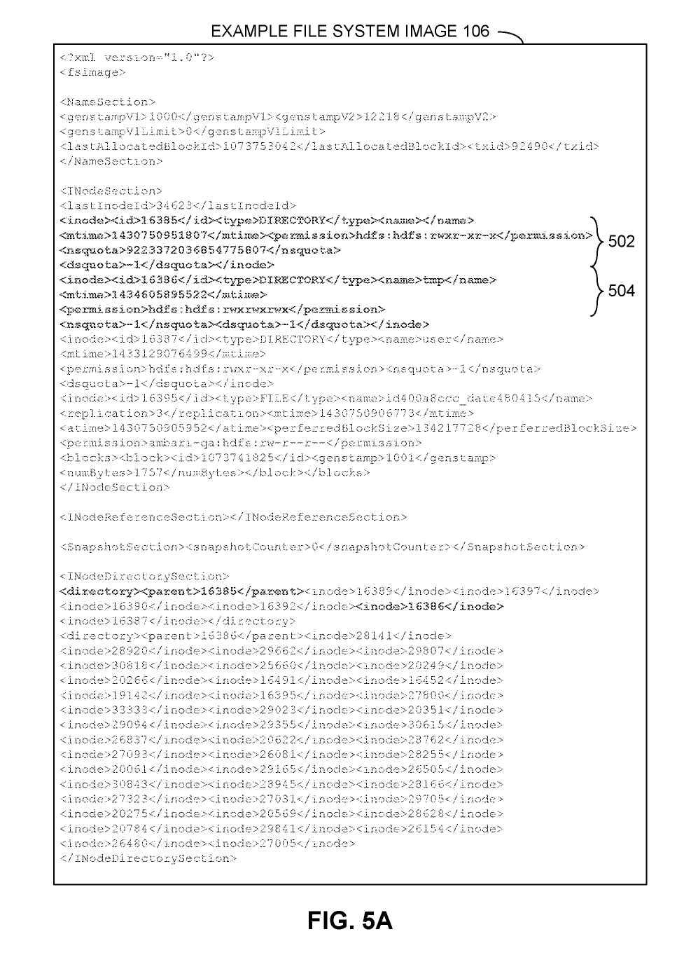

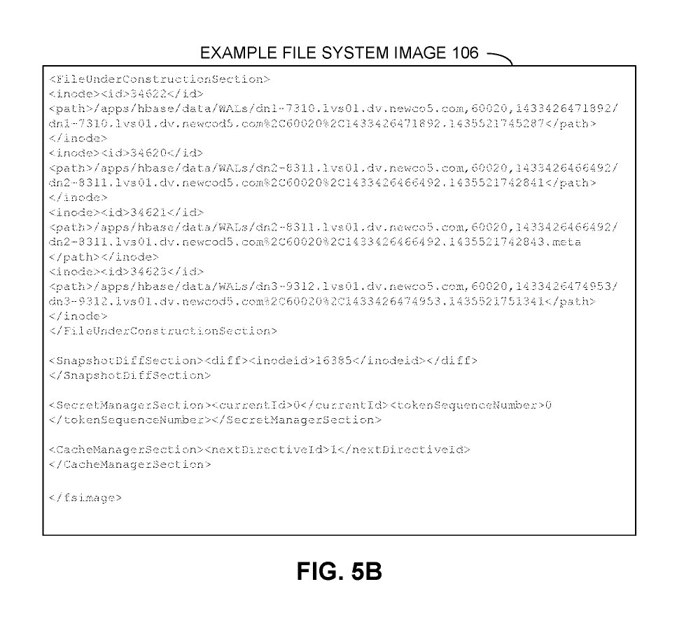

The image-to-memory loader 402 may access the file system image 106 via the active name node 102 or the standby name node 104 and store the image 106 as is, or according to some other format, to the image data memory 404, which may be local to the initial image loader/processor 202. An example of the file system image 106 is provided in FIGS. 5A and 5B. In this example, the hierarchical structure of the file system name space is specified in Extensible Markup Language (XML); however, other data formats for the file system image 106 may be employed in other embodiments. As shown in FIG. 5A, among the various data fields specified in the file system image 106 are an “INodeSection” and an “INodeDirectorySection”. Within the INodeSection are specified a plurality of inodes, or specific directories and files of the file system. Each inode is identified with a particular numerical identifier (“id”), and is associated with a particular inode type (“type,” e.g., “DIRECTORY,” “FILE,” etc.), name (“name”), modification timestamp (“mtime”), set of permissions (“permission”), and so on. Specifically indicated in bold in the INodeSection of FIG. 5A is an inode 502 for a root directory with an inode identifier of 16385, and an inode 504 for a “tmp” directory with an inode identifier of 16386.

Information describing the two individual inodes 502, 504, as well as others, are described in the INodeSection. In addition, the INodeDirectorySection provides information regarding how the inodes 502, 504, and others are interrelated in the file system hierarchy. In the specific example of FIG. 5A, the INodeDirectorySection specifies a number of directories (“directory”), each of which may specify a parent directory (“parent”), and a number of inodes (“inode”) included in the directory, each of which may be a file or another directory. Each of the inodes in the INodeDirectorySection is referenced via its numerical identifier from the INodeSection. In the bolded portion of the INodeDirectorySection of FIG. 5A, the directory entry for the root directory (identifier 16385) lists the “tmp” directory (identifier 16386) as being included in the root directory. Thus, a path name for the “tmp” directory would be “/tmp”. Consequently, a significant amount of processing of the file system image 106 may be required to extract data of interest regarding a particular directory or file.

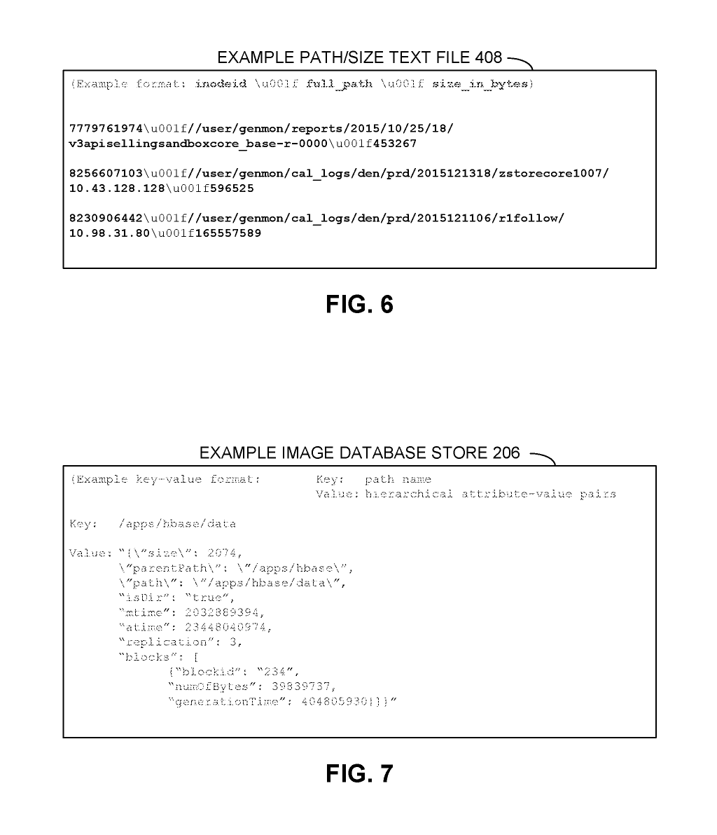

Once at least a portion of (or the entirety of) file system image 106 has been loaded into the image data memory 404, the image data extractor 406 may begin reading the file system image memory 404 and generating the path/size text file 408. FIG. 6 is an example of a portion of the path/size text file 408. In one embodiment, the path/size text file 408 may include a separate line or entry for each inode, with each line providing an identifier for the inode (“inodeid”), a full path name for that inode (“full_path”), and a size of the inode (“size_in_bytes”). In addition, a predetermined delimiter (in this case, an unsigned hexadecimal value of 001f (“\u001f”) may separate each of the fields for efficient processing.

Returning to FIG. 4, the data preparer 410 of the initial image loader/processor 202 may access the data of the path/size text file 408 and process that data to generate the database store loadable data 412. In one example, the path/size text file 408 provides an intermediate format for the data of file system image 106 to be used by the data preparer 410 as a basis for generating data for the image database store 206. Such a process may provide an efficient means of generating database-compatible data from the file system image 106, as the path/size text file 408 includes a more easily discernable description of each path compared to the file system image 106. In one example involving the use of an HDFS, the data preparer 410 may implement a “MapReduce” job in which one or more “map” tasks may retrieve or consume individual portions (e.g., one or more inodes) of the path/size text file 408 in parallel and provide those portions to one or more “reduce” tasks to generate the database store loadable data 412.

FIG. 7 is an example of data loadable within the image database store 206 employable by the initial image loader/processor of FIG. 4 and the transaction loader/processor of FIG. 8. In this example, the database format used is a key-value pair format for each inode, in which the key of each pair is the path name of the inode, and the value includes one or more hierarchical attribute-value pairs. An example of a database that employs a key-value pair format is Redis®, which is an in-memory database that may facilitate rapid database transactions, including fast incremental updates. In the specific example key-value pair depicted in FIG. 7, the key is the path name “/apps/hbase/data,” and the value includes a size of the inode (“size\”) in bytes, the path name of the parent inode (“parentPath\”), an indication of whether the inode is a directory (“isDir”), a modification timestamp (“mtime”), an accessed timestamp (“atime”), an indication of the number of times the inode is replicated in the file system (“replication”), and a list of the blocks that hold the data for the inode, including a block identifier (“blockid”), a number of bytes in the block (“numOfBytes”), and a timestamp of the generation of the block (“generationTime”). In other examples, greater or fewer types of information for each inode may be provided in the value portion of the key-value pair for the inode.

Returning to FIG. 4, the database store data loader 414 may take the database store loadable data 412 from the data preparer 410 and load that data into the image database store 206. In one example based on HDFS, the database store data loader 414 may be implemented as a “Map”-only job that receives and directly inserts the database store loadable data 412 into the image database store 206 without resorting to typical database operations associated with the database.

In some embodiments, the initial image loader/processor 202 is designed to perform the loading and processing of the file system image 106 within a minimum time period during which the data for any particular transaction or transaction segment is maintained in the edit log 110 of a journal node 108 so that the data representing the entire file system image 106 may be stored in the image database store 206 without any particular transaction being flushed or eliminated from the edit log 110 before the transaction loader/processor 204 loads and processes that transaction.

FIG. 8 is a block diagram of an example of the transaction loader/processor 204 of FIG. 2. As illustrated, the transaction loader/processor 204 may include a log-to-memory loader 804 configured to load transaction data from the edit log 110 to an edit transaction memory 806, and an edit transaction parser 808 to modify the image data in the image database store 206 based on the transaction data in the edit transaction memory 806. Also included in the transaction loader/processor 204 may be an access scheduler 802 that is configured to periodically trigger the log-to-memory loader 804 to access additional transaction data from the edit log 110.

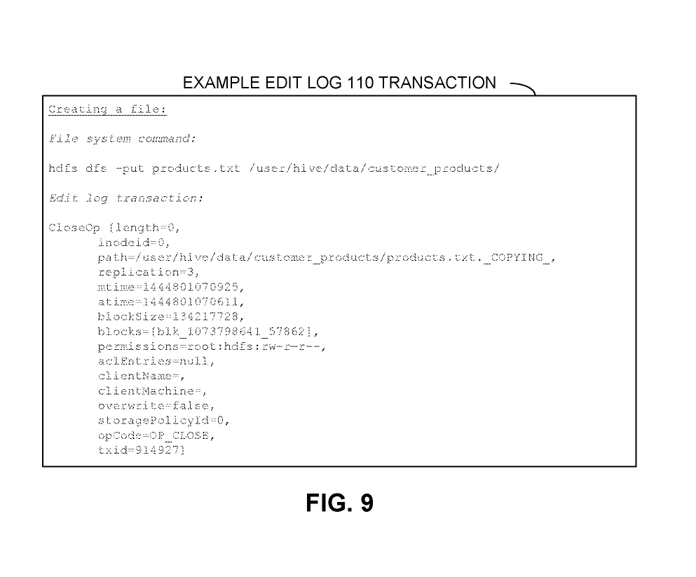

FIG. 9 is an example edit log transaction, an indication of which may be stored in the edit log 110 and accessed by the log-to-memory loader 804 for storage in the edit transaction memory 806, which may be local to the transaction loader/processor 204. In the particular example of FIG. 9, an HDFS command to create a file in a particular directory is received and executed by the file system (more specifically, the active name node 102 of FIG. 1, in one embodiment). More specifically, the command (“hdfs dfs”) indicates that a file system operation is to be performed in which a file (“products.txt”) is to be copied (“-put”) in a particular directory (“/user/hive/data/customer_products/”). As a result of executing the command, transaction data is generated for the edit log 110 by way of an edit log operation (“CloseOp”) that stores several different items of data regarding the transaction, such as a length associated with the transaction (“length”), an inode identifier (“inodeid”), a path to the directory under which the file is to be created (“path”), a replication factor (“replication”), a modification timestamp (“mtime”), an accessed timestamp (“atime”), a block size for this file (“blockSize”), a list of blocks used to store the file (“blocks”), and additional information. The transaction may also be associated with a transaction identifier (“txid”). The log-to-memory loader 804 may access such transactions in the edit log 110, including at least some of the data described above, and store the data in the edit transaction memory 806. As mentioned above, other types of file system commands (e.g., create a directory, delete a directory, delete a file, update a file, copy a file to another location, etc.) may be requested by one or more clients and executed by the name node 102, 104, with corresponding transaction data being recorded in the edit log 110.

In some examples, multiple transactions may be grouped in the edit log 110 as transaction segments, each of which may be associated with a particular time period. In such examples, the log-to-memory loader 804 may load the transactions in groups according to their segments, as the journal node 108 may store and release the transactions on a segment-by-segment basis.

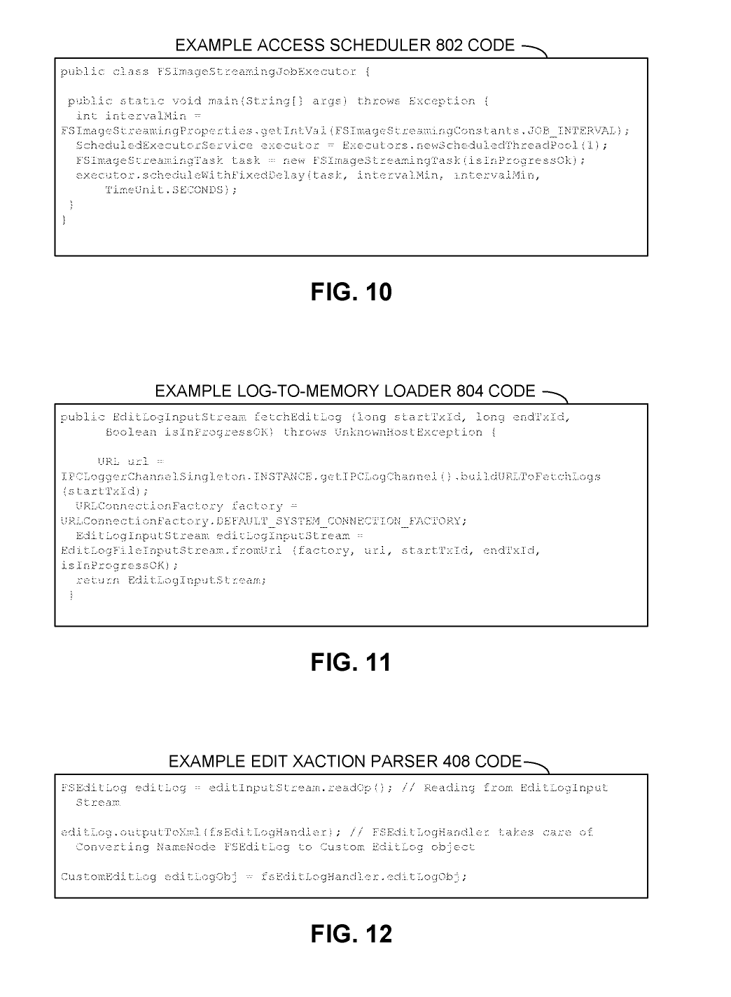

Returning to FIG. 8, the access scheduler 802 may periodically trigger the execution of the log-to-memory loader 804 to load any additional transactions currently available in the edit log 110. FIG. 10 is an example Java® code segment for the access scheduler 802 of the transaction loader/processor 204 of FIG. 8. In this example, in the “FSImageStreamingJobExecutor” class, the “ScheduledExecutorService” application programming interface (API) of the Java® standard library is employed to provide a scheduler with a fixed time delay to initate the image streaming “task” (of type “FSImageStreamingTask”) to initiate the log-to-memory loader 804 to access and store the transactions from the edit log 110 in the edit transaction memory 806. However, other schedulers may be employed in other embodiments. In one example, the log-to-memory loader 804 may be triggered once every thirty seconds, but other time delays may be appropriate in other embodiments.

FIG. 11 is an example code segment for the log-to-memory loader 804 employable in the transaction loader/processor 204 of FIG. 8. In this embodiment, the IPCLoggerChannel class of the API package provided for the HDFS NameNode is used to download transactions from the edit log 110, given a starting transaction identifier (“startTxId”) and an ending transaction identifier (“endTxId”). Other examples may employ a different class or API to perform the accessing or downloading of the transaction data into the edit transaction memory 806.

Referencing FIG. 8 once again, the edit transaction parser 808 may be configured to modify the image data in the image database store 206 based on the transaction data in the edit transaction memory 806, as mentioned above. FIG. 12 is an example code segment for the edit transaction parser 808 in which a custom Simple API for XML (SAX) parser is employed to parse the incoming data from the edit log 110 (“editLog”) to generate a custom object (“editLogObj”), and make the corresponding changes to the image database store 206 based on the custom object via the database (e.g., a key-value pair database).

FIG. 13 is a block diagram of an example image analyzer 208 employable in the file system image processing system 120 of FIG. 1. As illustrated in FIG. 13, the image analyzer 208 may include a general real-time system query module 1302 that may receive a wide variety of inputs specifying the particular types of data to be accessed in the image database store 206, the types of processing to perform on the accessed data, and the types of output data to be provided as a result of the processing. In some embodiment, the output data may be in the form of a report, an alert, or other type of output that may be transmitted to a computer, mobile device, or other communication device for the use of an interested party, such as a file system administrator, compliance auditor, or other personnel. In other examples, the output provided by the general real-time system query module 1302, as well as other modules of the image analyzer 208, may provide output directly to an API or other programmatic interface to a policy manager or other entity to cause one or more changes to the operation of the file system.

In FIG. 13, the image analyzer 208 may also include one or more special-purpose modules that provide particular types of analysis and associated output data. These modules may include a large file/directory deletion detection module 1304, a replicated file reduction detection module 1306, a files-per-user determination module 1308, a small file detection module 1310, a disk/name space quota usage determination module 1312, a duplicate file detection module 1314, an abandoned file detection module 1316, and a last file/directory access detection module 1318. For example, the large file/directory deletion detection module 1304 may provide an alert as to the deletion of a large file or directory that may be inadvertent. The replicated file reduction detection module 1306 may warn of a risk that an expected redundancy regarding one or more files has been reduced or compromised. The files-per-user determination module 1308 may provide an indication of which users are storing greater or fewer numbers of files compared to some average. The small file detection module 1310 may compare the size of files versus the block size being employed for the files to determine whether storage space is being utilized efficiently. The disk/name space quota usage determination module 1312 may compare the usage of the name node 102, 104 and/or the data nodes 112 to determine which users are approaching their assigned quota in each space. The duplicate file detection module 1314 may determine the distribution of duplicated files versus file size to determine whether file duplication is being performed efficiently while providing adequate protection against storage system failures. The abandoned file detection module 1316 may determine which files may be deleted or archived based on inactivity involving the files, and may determine whether such files are associated with a particular user or client that may no longer be accessing the data storage cluster 100 or associated file system. The last file/directory access detection module 1318 may determine the last day and/or time any file or directory in the file structure has been accessed, and may provide additional information, such as the entity that accessed the file or directory, the type of access (update, read-only, etc.), and so forth. Many other types of modules performing various analyses may be provided in other examples of the image data analyzer 208.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application-Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-13 may implemented in some embodiments in the context of a machine and an associated software architecture. The sections below describe representative software architectures and machine (e.g., hardware) architectures that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here as those of skill in the art can readily understand how to implement the invention in different contexts from the disclosure contained herein.

### Software Architecture

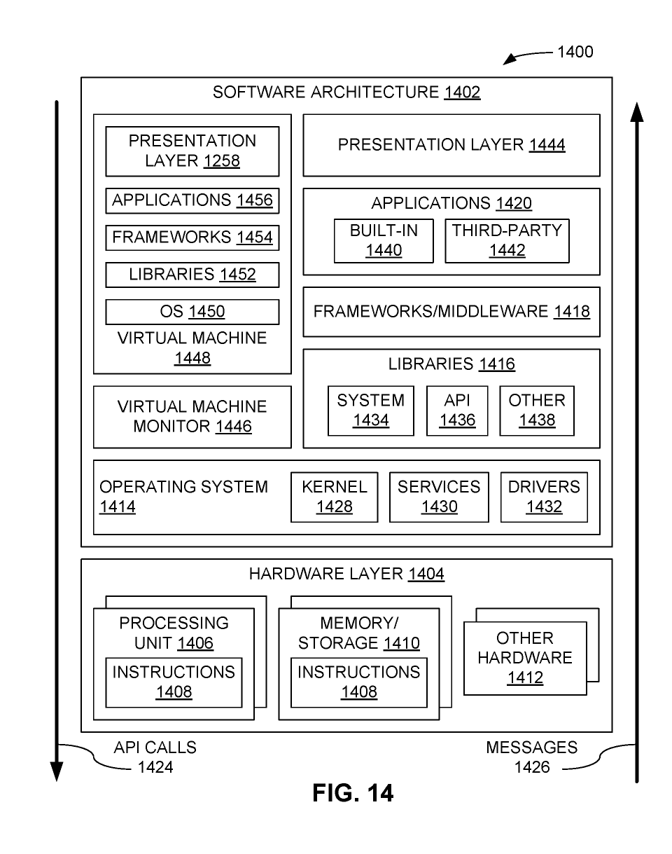

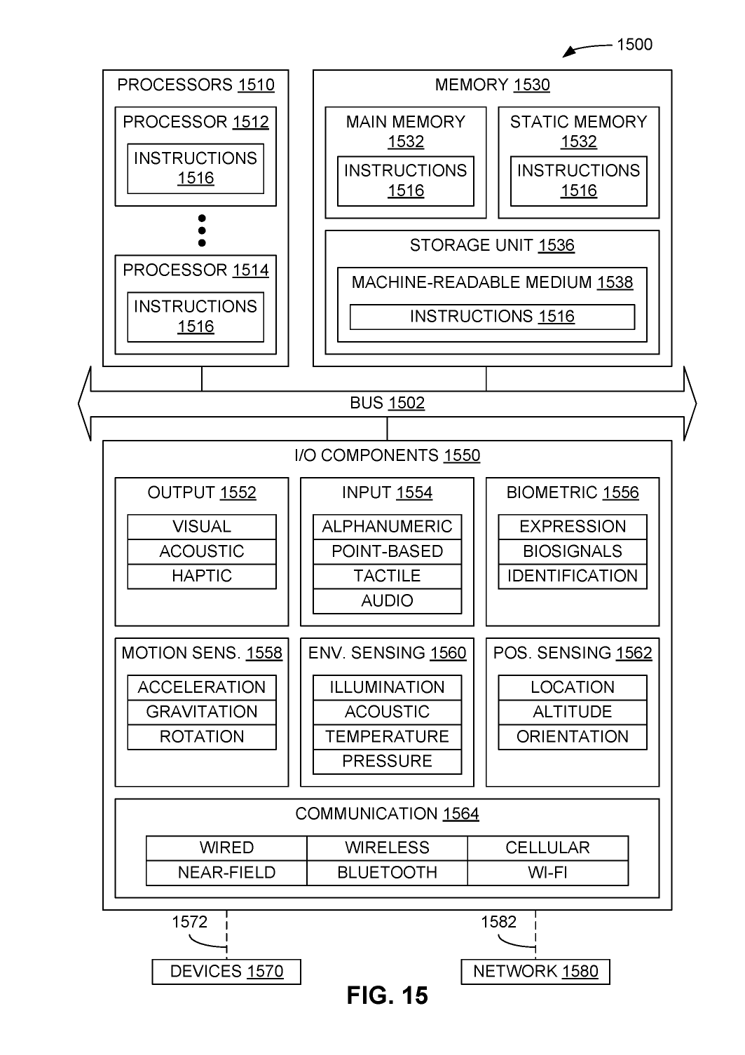

FIG. 14 is a block diagram 1400 illustrating a representative software architecture 1402, which may be used in conjunction with various hardware architectures herein described. FIG. 14 is merely a non-limiting example of a software architecture and it will be appreciated that many other architectures may be implemented to facilitate the functionality described herein. The software architecture 1402 may be executing on hardware such as machine 1500 of FIG. 15 that includes, among other things, processors 1510, memory 1530, and I/O components 1550. A representative hardware layer 1404 is illustrated and can represent, for example, the machine 1500 of FIG. 15. The representative hardware layer 1404 comprises one or more processing units 1406 having associated executable instructions 1408. Executable instructions 1408 represent the executable instructions of the software architecture 1402, including implementation of the methods, modules, and so forth associated with the file system image processing system 120 of FIG. 2, the method 300 of FIG. 3, and the associated modules, components, and the like of FIGS. 4-13. Hardware layer 1404 also includes memory and/or storage modules 1410, which also have executable instructions 1408. Hardware layer 1404 may also comprise other hardware as indicated by 1412 which represents any other hardware of the hardware layer 1404, such as the other hardware illustrated as part of machine 1500.

In the example architecture of FIG. 14, the software architecture 1402 may be conceptualized as a stack of layers where each layer provides particular functionality. For example, the software 1402 may include layers such as an operating system 1414, libraries 1416, frameworks/middleware 1418, applications 1420 and presentation layer 1422. Operationally, the applications 1420 and/or other components within the layers may invoke application programming interface (API) calls 1424 through the software stack and receive a response, returned values, and so forth illustrated as messages 1426 in response to the API calls 1424. The layers illustrated are representative in nature and not all software architectures have all layers. For example, some mobile or special purpose operating systems may not provide a frameworks/middleware layer 1418, while others may provide such a layer. Other software architectures may include additional or different layers.

The operating system 1414 may manage hardware resources and provide common services. The operating system 1414 may include, for example, a kernel 1428, services 1430, and drivers 1432. The kernel 1428 may act as an abstraction layer between the hardware and the other software layers. For example, the kernel 1428 may be responsible for memory management, processor management (e.g., scheduling), component management, networking, security settings, and so on. The services 1430 may provide other common services for the other software layers. The drivers 1432 may be responsible for controlling or interfacing with the underlying hardware. For instance, the drivers 1432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1416 may provide a common infrastructure that may be utilized by the applications 1420 and/or other components and/or layers. The libraries 1416 typically provide functionality that allows other software modules to perform tasks in an easier fashion than to interface directly with the underlying operating system 1414 functionality (e.g., kernel 1428, services 1430 and/or drivers 1432). The libraries 1416 may include system 1434 libraries (e.g., C standard library) that may provide functions such as memory allocation functions, string manipulation functions, mathematic functions, and the like. In addition, the libraries 1416 may include API libraries 1436 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1416 may also include a wide variety of other libraries 1438 to provide many other APIs to the applications 1420 and other software components/modules.

The frameworks 1418 (also sometimes referred to as middleware) may provide a higher-level common infrastructure that may be utilized by the applications 1420 and/or other software components/modules. For example, the frameworks 1418 may provide various graphic user interface (GUI) functions, high-level resource management, high-level location services, and so forth. The frameworks 1418 may provide a broad spectrum of other APIs that may be utilized by the applications 1420 and/or other software components/modules, some of which may be specific to a particular operating system or platform.

The applications 1420 may include built-in applications 1440 and/or third party applications 1442. Examples of representative built-in applications 1440 may include, but are not limited to, a contacts application, a browser application, a book reader application, a location application, a media application, a messaging application, and/or a game application. Third party applications 1442 may include any of the built-in applications as well as a broad assortment of other applications. In a specific example, the third party application 1442 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1442 may invoke the API calls 1424 provided by the mobile operating system such as operating system 1414 to facilitate functionality described herein.

The applications 1420 may utilize built-in operating system functions (e.g., kernel 1428, services 1430 and/or drivers 1432), libraries (e.g., system 1434, APIs 1436, and other libraries 1438), and frameworks/middleware 1418 to create user interfaces to interact with users of the system. Alternatively, or additionally, in some systems, interactions with a user may occur through a presentation layer, such as presentation layer 1444. In these systems, the application/module “logic” can be separated from the aspects of the application/module that interact with a user.

Some software architectures utilize virtual machines. In the example of FIG. 14, this is illustrated by virtual machine 1448. A virtual machine creates a software environment where applications/modules can execute as if they were executing on a hardware machine (such as the machine of FIG. 15, for example). A virtual machine is hosted by a host operating system (operating system 1414 in FIG. 15) and typically, although not always, has a virtual machine monitor 1446, which manages the operation of the virtual machine as well as the interface with the host operating system (i.e., operating system 1414). A software architecture executes within the virtual machine such as an operating system 1450, libraries 1452, frameworks/middleware 1454, applications 1456 and/or presentation layer 1458. These layers of software architecture executing within the virtual machine 1448 can be the same as corresponding layers previously described or may be different.

### Example Machine Architecture and Machine-ReadableMedium

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. For example, the instructions may cause the machine to execute the flow diagram of FIG. 3. Additionally, or alternatively, the instructions may implement the initial image loader/processor 202, the transaction loader/processor 204, and the image data analyzer 208 of FIG. 2, as well as the various modules and associated code segments thereof, as illustrated in FIGS. 4-13, and so forth. The instructions transform the general, non-programmed machine into a particular machine programmed to carry out the described and illustrated functions in the manner described. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), or any machine capable of executing the instructions 1516, sequentially or otherwise, that specify actions to be taken by machine 1500. Further, while only a single machine 1500 is illustrated, the term “machine” shall also be taken to include a collection of machines 1500 that individually or jointly execute the instructions 1516 to perform any one or more of the methodologies discussed herein.

The machine 1500 may include processors 1510, memory 1530, and I/O components 1550, which may be configured to communicate with each other such as via a bus 1502. In an example embodiment, the processors 1510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1512 and processor 1514 that may execute instructions 1516. The term “processor” is intended to include multi-core processor that may comprise two or more independent processors (sometimes referred to as “cores”) that may execute instructions contemporaneously. Although FIG. 15 shows multiple processors, the machine 1500 may include a single processor with a single core, a single processor with multiple cores (e.g., a multi-core process), multiple processors with a single core, multiple processors with multiples cores, or any combination thereof.

The memory/storage 1530 may include a memory 1532, such as a main memory, or other memory storage, and a storage unit 1536, both accessible to the processors 1510 such as via the bus 1502. The storage unit 1536 and memory 1532 store the instructions 1516 embodying any one or more of the methodologies or functions described herein. The instructions 1516 may also reside, completely or partially, within the memory 1532, within the storage unit 1536, within at least one of the processors 1510 (e.g., within the processor's cache memory), or any suitable combination thereof, during execution thereof by the machine 1500. Accordingly, the memory 1532, the storage unit 1536, and the memory of processors 1510 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Electrically Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1516. The term “machine-readable medium” shall also be taken to include any medium, or combination of multiple media, that is capable of storing instructions (e.g., instructions 1516) for execution by a machine (e.g., machine 1500), such that the instructions, when executed by one or more processors of the machine 1500 (e.g., processors 1510), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1550 may include a wide variety of components to receive input, provide output, produce output, transmit information, exchange information, capture measurements, and so on. The specific I/O components 1550 that are included in a particular machine will depend on the type of machine. For example, portable machines such as mobile phones will likely include a touch input device or other such input mechanisms, while a headless server machine will likely not include such a touch input device. It will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 may include output components 1552 and input components 1554. The output components 1552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1550 may include biometric components 1556, motion components 1558, environmental components 1560, or position components 1562 among a wide array of other components. For example, the biometric components 1556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1558 may include acceleration sensor components (e.g., accelerometer), gravitation sensor components, rotation sensor components (e.g., gyroscope), and so forth. The environmental components 1560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1550 may include communication components 1564 operable to couple the machine 1500 to a network 1580 or devices 1570 via coupling 1582 and coupling 1572 respectively. For example, the communication components 1564 may include a network interface component or other suitable device to interface with the network 1580. In further examples, communication components 1564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1570 may be another machine or any of a wide variety of peripheral devices (e.g., a peripheral device coupled via a Universal Serial Bus (USB)).

Moreover, the communication components 1564 may detect identifiers or include components operable to detect identifiers. For example, the communication components 1564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1564, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network and the coupling 1582 may be a Code Division Multiple Access (CDMA) connection, a Global System for Mobile communications (GSM) connection, or other type of cellular or wireless coupling. In this example, the coupling 1582 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1516 may be transmitted or received over the network 1580 using a transmission medium via a network interface device (e.g., a network interface component included in the communication components 1564) and utilizing any one of a number of well-known transfer protocols (e.g., hypertext transfer protocol (HTTP)). Similarly, the instructions 1516 may be transmitted or received using a transmission medium via the coupling 1572 (e.g., a peer-to-peer coupling) to devices 1570. The term “transmission medium” shall be taken to include any intangible medium that is capable of storing, encoding, or carrying instructions 1516 for execution by the machine 1500, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A file system image processing system comprising:
an image processor module comprising at least one hardware processor of a machine, the image processor module to access a file system image stored at a first server of a file system while the file system image is not being modified, and to store a representation of the file system image; and
a transaction processor module to repeatedly access transaction data stored at a second server of the file system separate from the first server, the transaction data describing file system edit transactions not represented in the accessed file system image, the transaction processor module to modify the representation of the file system image based on the accessed transaction data.

2. The file system image processing system of claim 1, the representation of the file system image being a database-compatible representation of the file system image, the representation being stored at a database store separate from the first server.

3. The file system image processing system of claim 1, the image processor module comprising:
an image-to-memory loader to retrieve the file system image from a name space server of the file system and to load the file system image to a memory;
an image data extractor to generate a text file comprising file image data based on the file system image in the memory;
a data preparer to generate database-compatible image data based on the file image data of the text file; and
a database data loader to load the database-compatible image data to a database store as the representation of the file system image.

4. The file system image processing system of claim 3, the file image data of the text file comprising a path name and a path size for each of a plurality of nodes indicated in the file system image.

5. The file system image processing system of claim 4, the database-compatible image data comprising a plurality of key-value pairs, each of the key-value pairs comprising the path name and the path size for one of the plurality of nodes indicated in the file system image.

6. The file system image processing system of claim 1, the transaction processor module comprising:
a log-to-memory loader to retrieve file transaction data describing at least one file edit transaction executed on the file system from an edit log of a journal node server of the file system and to load the file transaction data to a memory; and
an edit transaction parser to parse the file transaction data of the memory and to modify the representation of the file system image based on the parsed file transaction data.

7. The file system image processing system of claim 6, the log-to-memory loader to retrieve at least one segment of the file transaction data, each of the at least one segment comprising the file transaction data for one or more of the file edit transactions during a corresponding time period.

8. The file system image processing system of claim 6, the transaction processor module further comprising:
an access scheduler to cause the log-to-memory loader to retrieve file transaction data not previously retrieved from the edit log once per a predetermined time period.

9. The file system image processing system of claim 1, further comprising:
at least one image data analyzer to analyze the representation of the file system image to determine at least one characteristic of the file system.

10. The file system image processing system of claim 9, the at least one image data analyzer to detect deletion of a file exceeding a predetermined size in the file system based on the representation of the file system image, and to transmit an indication of the detected deletion.

11. The file system image processing system of claim 9, the at least one image data analyzer to detect at least one file having a size less than a predetermined size based on the representation of the file system image, and to transmit an indication of the at least one detected file.

12. The file system image processing system of claim 9, the at least one image data analyzer to determine a number of files owned by each of a plurality of users of the file system, and to transmit an indication of the number of files owned by each of the plurality of users.

13. The file system image processing system of claim 9, the at least one image data analyzer to determine a distribution of duplicated files versus file size of the file system, and to transmit an indication of the distribution.

14. The file system image processing system of claim 9, the at least one image data analyzer to detect a last access of at least one file of the file system, and to cause transmit information describing the last access of the at least one file.

15. The file system image processing system of claim 9, the at least one image data analyzer to detect at least one abandoned file of the file system, and to transmit an indication of the abandoned file.

16. The file system image processing system of claim 9, the at least one image data analyzer to compare disk space usage of at least a portion of the file system to a quota, and to transmit an alert based on the disk space usage being greater than a predetermined portion of the quota.

17. A method comprising:
accessing, using at least one hardware processor of a machine, a file system image at a first server of a file system while the file system image is not being modified;
storing a representation of the file system image;
repeatedly accessing transaction data stored at a second server of the file system separate from the first server, the transaction data describing file system edit transactions not represented in the accessed file system image; and
modifying the representation of the file system image based on the accessed transaction data.

18. The method of claim 17, the representation of the file system image comprising a database-compatible representation of the file system image, the storing of the representation occurring at a database store separate from the first server.

19. The method of claim 17, further comprising analyzing the representation of the file system image to determine at least one characteristic of the file system

20. A system comprising:
a database store;
at least one hardware processor; and
memory having stored thereon instructions that, when executed by the at least one hardware processor, cause the system to perform operations comprising:
accessing a file system image at a first server of a file system while the file system image is not being modified;
storing a database-compatible representation of the file system image at the database store;
repeatedly accessing transaction data stored at a second server of the file system separate from the first server, the transaction data describing file system edit transactions not represented in the accessed file system image; and
modifying the representation of the file system image based on the accessed transaction data.
